(19) United States
(12) Patent Application Publication
(10) Pub. No.: US 2013/0009576 A1
(43) Pub. Date: Jan. 10, 2013

(54) MOTOR CONTROLLER HAVING ENERGY STORAGE UNIT

(75) Inventors: Yasusuke IWASHITA, Minamitsuru-gun (JP); Hiroyuki KAWAMURA, Minamitsuru-gun (JP); Satoshi IKAI, Minamitsuru-gun (JP)

(73) Assignee: FANUC CORPORATION, Minamitsuru-gun (JP)

(21) Appl. No.: 13/494,095

(22) Filed: Jun. 12, 2012

(30) Foreign Application Priority Data
Jul. 4, 2011 (JP) 2011-148365

(51) Int. Cl. H02P 27/06

(52) U.S. Cl. 318/400.3

(57) ABSTRACT

A motor controller includes: a converter circuit for converting AC power to DC power; an inverter circuit connected to a DC side of the converter circuit and converting DC power to AC power for driving a motor or converting AC power regenerated from the motor to DC power; an energy storage unit connected to the DC side of the converter circuit and the inverter circuit and storing or outputting DC power; and a control unit controlling amount of DC power to be stored or output in/from the energy storage unit on the basis of a motor operation instruction instructing operation of the motor.

### BACKGROUND OF THE INVENTION

1. Field of the Invention

The present invention relates to a motor controller for controlling a motor which converts alternating-current (AC) power from an AC power supply to direct-current (DC) power, further converts the DC power to AC power, and uses converted AC power as drive power. More specifically, the invention relates to a motor controller having an energy storage unit which stores power supplied from an AC power supply and power regenerated from a motor and can supply the stored power to the motor.

2. Description of Related Art

In a machine tool system, a servo motor (hereinbelow, simply referred to as “motor”) is provided for each drive shaft of a machine tool, and motors are controlled by a motor controller. The motor controller performs control by giving an instruction of position, speed, or torque of motor rotation to motors of the number of control axes driving the drive shafts of the machine tools.

A motor controller has a converter circuit as an AC-DC converter converting commercial AC power of three phases to DC power and an inverter circuit as a DC-AC converter connected to the DC side of the converter circuit and converting the DC power output from the converter circuit to AC power of desired frequency which is supplied as drive power of a motor unit. The motor controller controls the position, speed, or torque of motor rotation of the motor unit connected to the AC side of the inverter circuit.

In many cases, inverter circuits of the same number as that of motors are provided to supply the drive power to each of the motors provided for a plurality of drive shafts in a machine tool. On the other hand, in many cases, a single converter circuit is provided for a plurality of inverter circuits for the purpose of reducing the cost of the motor controller and occupation space. That is, in a motor controller, by supplying the DC power to a plurality of inverter circuits by a single converter circuit, the cost and occupation space is reduced as compared with the case where a plurality of converter circuits are provided.

In the motor controller constructed as described above, to stably and reliably drive the plurality of motor units, sufficient drive power has to be supplied reliably to each of the plurality of motors. Consequently, a converter circuit converting commercial AC power of three phases to DC power and whose maximum output is larger than a sum of maximum outputs of the plurality of motors has to be selected. In some instances, the capacity of an AC power supply is increased.

For such a reason, to reduce the capacity of the AC power supply and the capacity of the converter circuit, there is a case that an energy storage unit for storing power supplied from the AC power supply and power regenerated from a motor and supplying again the stored power to the motor is provided on the DC side of the converter circuit and the DC side of the inverter circuit. In this case, the AC power regenerated from the motor has to be converted to DC power which can be stored in the energy storage unit, so that the inverter circuit is configured as a semiconductor power converter capable of not only converting DC power to AC power but also converting AC power to DC power, i.e., universally converting power. By decreasing the maximum output of the AC power supply or the maximum conversion output (hereinbelow, simply referred to as “peak value”) of the converter circuit by providing such an energy storage unit, the capacity of the AC power supply and the capacity of the converter circuit is reduced.

An example of the energy storage unit is a capacitor.

There is also a technique using a flywheel as the energy storage unit, as described in Japanese Unexamined Patent Application Publication No. 2008-023599. According to the invention disclosed in Japanese Unexamined Patent Application Publication No. 2008-023599, voltage on the DC side of a converter circuit connected to an AC power supply, voltage on the DC side of a plurality of inverter circuits passing current to a plurality of motors, and voltage of a flywheel storage device connected to the DC side of the converter circuit and the DC side of the inverter circuit are controlled in a lump.

A motor controller having such an energy storage unit detects direct current flowing from the converter circuit into the inverter circuit, calculates power consumed by the motor or regenerated from the motor by using the detection value of the direct current and, in accordance with the calculated power, stores power in the energy storage unit or outputting power from the energy storage unit. To use the detection value of the direct current for the control of the energy storage unit, a filter for removing a noise component from the detection value of the direct current is provided in the motor controller. However, due to the filter, the current detection value has a delay in time. Due to a characteristic of the control system and the energy storage unit, delay in time occurs in a period between detection of direct current and start of storing operation or supplying operation of the energy storage unit. Since the energy storage unit is operated using a current detection value having a delay as described above, a response delay to an instruction value is inevitably large. Due to such a delay, the peak value of the AC power supply and the converter circuit cannot be decreased so much and, accordingly, the capacity of the AC power supply and the capacity of the converter circuit cannot be reduced so much.

### SUMMARY OF THE INVENTION

In view of the problems, an object of the present invention is to provide a compact, low-cost motor controller, in which the capacity of the AC power supply and the capacity of the converter circuit are reduced, for a motor controller including: a converter circuit for converting AC power from an AC power supply to DC power; an inverter circuit converting DC power to AC power for driving a motor or converting AC power regenerated from the motor to DC power; and an energy storage unit storing or outputting DC power.

To realize the object, in the present invention, a motor controller includes: a converter circuit for converting AC power to DC power; an inverter circuit connected to a DC side of the converter circuit and converting DC power to AC power for driving a motor or converting AC power regenerated from the motor to DC power; an energy storage unit connected to the DC sides of the converter circuit and the inverter circuit and storing or outputting DC power; and a control unit controlling DC power amount to be stored in or output from the energy storage unit on the basis of a motor operation instruction instructing angle, angular velocity, or angular acceleration to the motor.

The control unit has: a power calculating unit calculating a prediction value of power consumed by the motor or regenerated from the motor on the basis of the motor operation instruction; and an energy control unit controlling the energy storage unit so that the DC power amount follows the prediction value. The control unit has a current instruction value generating unit, using the motor operation instruction and a detection value on rotation of the motor, which generates a current instruction value to the inverter circuit, as an instruction value instructing the inverter circuit to output alternating current necessary for the motor to operate in accordance with the motor operation instruction.

The power calculating unit may calculate the prediction value by multiplying the current instruction value to the inverter circuit, angular velocity detected on the motor as the detection value on the rotation of the motor, and torque constant of the motor. Alternatively, the power calculating unit may calculate the prediction value by multiplying an angular velocity instruction value as the motor operation instruction, an angular acceleration instruction value obtained by differentiating the angular velocity instruction value, and inertia of the drive shaft of the motor.

When the converter circuit mutually converts AC power from an AC power supply and DC power, the energy control unit may control the DC power amount to be stored in or output from the energy storage unit within a range not exceeding maximum conversion permissible power of the converter circuit capable of converting the AC power and DC power mutually. Alternatively, when the converter circuit mutually converts AC power from the AC power supply and the DC power, the energy control unit may control the DC power amount to be stored in or output from the energy storage unit within a range not exceeding maximum supply power which can be supplied from the AC power supply connected to the converter circuit, to the converter circuit.

The energy storage unit may be a capacitor connected to the DC sides of the converter circuit and the inverter circuit. In this case, the energy control unit controls the DC power amount to be stored in or output from the capacitor on the basis of the prediction value calculated by the power calculating unit. Specifically, in this case, the energy storage unit includes: a capacitor connected to the DC sides of the converter circuit and the inverter circuit; and a capacitor control unit controlling the capacitor to store or output DC power in accordance with an instruction from the energy control unit based on the prediction value calculated by the power calculating unit. Alternatively, the energy storage unit may include: a motor with inertia; an inverter circuit for the motor with inertia, whose DC side is connected to the DC sides of the converter circuit and the inverter circuit and whose AC side is connected to an input terminal of the motor with inertia; a motor speed detecting unit detecting speed of the motor with inertia; and a control unit for the motor with inertia, using the prediction value and a detection value of speed of the motor with inertia received from the motor speed detecting unit, generating a current instruction value to the inverter circuit for the motor with inertia so that the DC power amount follows the prediction value.

### BRIEF DESCRIPTION OF THE DRAWINGS

The present invention will be understood more clearly with reference to the following accompanying drawings.

FIG. 1 is a block diagram illustrating a motor controller controlling a single motor in an embodiment of the present invention.

FIG. 2 is a block diagram illustrating a motor controller controlling a plurality of motors in the embodiment of the invention.

FIG. 3 is a flowchart showing the operation flow of the motor controller as the embodiment of the invention.

FIG. 4 is a block diagram for explaining a first method of calculating a prediction value of power in the embodiment of the invention.

FIG. 5 is a block diagram for explaining a second method of calculating a prediction value of power in the embodiment of the invention.

FIG. 6 is a block diagram for explaining a first concrete example of an energy storage unit in the embodiment of the invention.

FIG. 7 is a block diagram for explaining a second concrete example of the energy storage unit in the embodiment of the invention.

FIG. 8 is a diagram for explaining suppression of a peak value of AC power supplied from an AC power supply in the case of applying the motor controller according to the embodiment of the invention and shows waveforms of the case where there is no energy storage unit, waveforms of the related art provided with the energy storage unit, and waveforms of the present invention.

### DETAILED DESCRIPTION

Hereinafter, with reference to the drawings, a motor controller having an energy storage unit will be described. It is to be understood that the present invention, however, is not limited to the drawings and embodiments to be described below.

For example, in a machine tool system, a motor (servo motor) is provided for each of drive shafts of a machine tool. In this case, in a motor controller, inverter circuits of the same number as that of motors are provided to supply drive power to each of the motors, and a single converter circuit is provided for the plurality of inverter circuits for the purpose of reducing the cost and occupation space of the motor controller.

In an embodiment of the invention to be described hereinafter, a motor controller for controlling a single motor (servo motor) will be described. However, as will be described later, the present invention can be also applied to the case of controlling a plurality of motors. That is, the number of motors to be controlled does not limit the present invention but may be plural. Hereinafter, it is assumed that components to which the same reference numerals and the same reference numerals with suffix numbers are designated in different drawings are components having the same function.

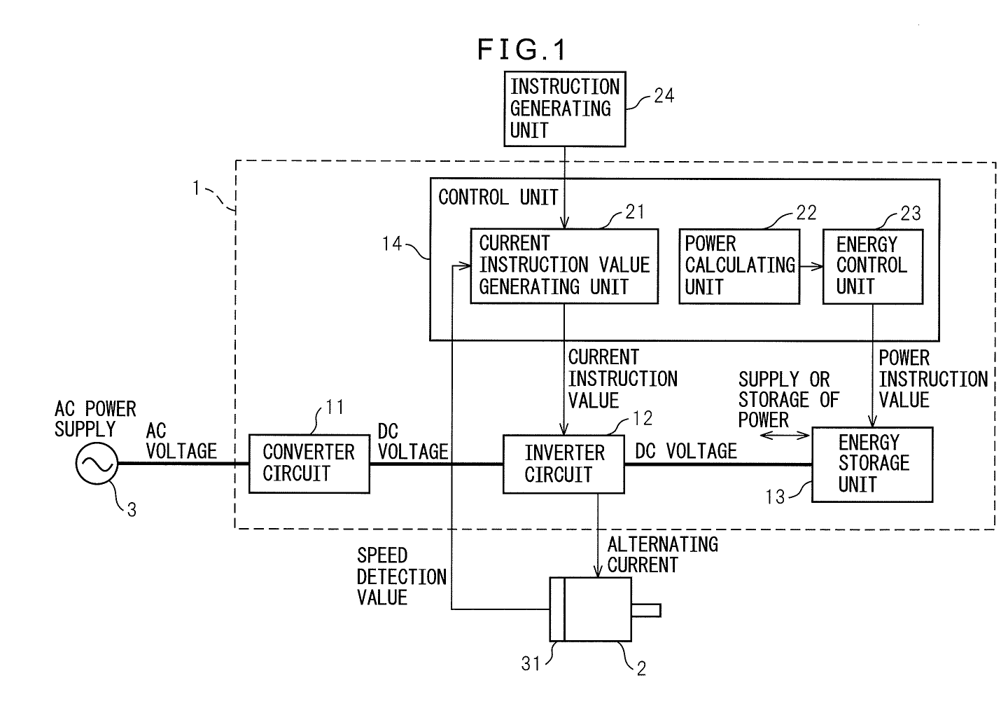

FIG. 1 is a block diagram showing a motor controller for controlling a single motor. In the example shown in FIG. 1, since the number of controlled axis of a machine tool is set to one, one motor 2 is provided, and a motor controller 1 controls the motor 2.

As shown in FIG. 1, the motor controller 1 as an embodiment of the present invention has a converter circuit 11 converting AC power from an AC power supply 3 to DC power, an inverter circuit 12 connected to a DC side of the converter circuit 11 and converting DC power to AC power for driving the motor 2 or converting AC power regenerated from the motor 2 to DC power, an energy storage unit 13 connected to DC sides of the converter circuit 11 and the inverter circuit 12 and storing or outputting DC power, and a control unit 14 controlling amount of DC power to be stored or output in/from the energy storage unit 13 on the basis of a motor operation instruction which instructs operation of the motor 2. The control unit 14 can be a processor which can determine process. The motor operation instruction will be described later.

An instruction generating unit 24 generates a motor operation instruction instructing operation of the motor 2 and supplies the motor operation instruction to a current instruction value generating unit 21 in the control unit 14.

The motor 2 is provided with a speed detecting unit 31 for detecting speed of the rotating motor 2. Although the speed detecting unit 31 detects the speed of the rotating motor 2 in this case, it may detect speed of rotation of a control axis of a machine tool to which the rotary shaft of the motor 2 is connected. Although the speed detecting unit 31 detecting the speed of rotation of the motor 2 or the control axis is used in the embodiment, a position detecting unit for detecting rotation position of the motor 2 or the position of the control axis connected to the motor 2 may be used. The speed detecting unit or the position detecting unit detects the position or speed by connecting, for example, a scale or a rotary encoder to the rotary shaft of the motor or the control axis of the machine tool to which the motor is connected. There are relations such that, by differentiating a position detection value, a speed detection value is obtained and, by integrating a speed detection value, a position detection value is obtained.

The control unit 14 has the current instruction value generating unit 21, a power calculating unit 22, and an energy control unit 23. Using the motor operation instruction generated by the instruction generating unit 24 and the detection value on the rotation of the motor 2 detected by the speed detecting unit 31, the current instruction value generating unit 21 generates a current instruction value to the inverter circuit 12, as an instruction value by which alternating current necessary for the motor 2 to operate is output from the inverter circuit 12 in accordance with the motor operation instruction. The power calculating unit 22 calculates a prediction value of power consumed by the motor 2 or regenerated from the motor 2 on the basis of the motor operation instruction. The energy control unit 23 controls the energy storage unit 13 so that the DC power amount to be stored or output in/from the energy storage unit 13 follows the prediction value calculated by the power calculating unit 22.

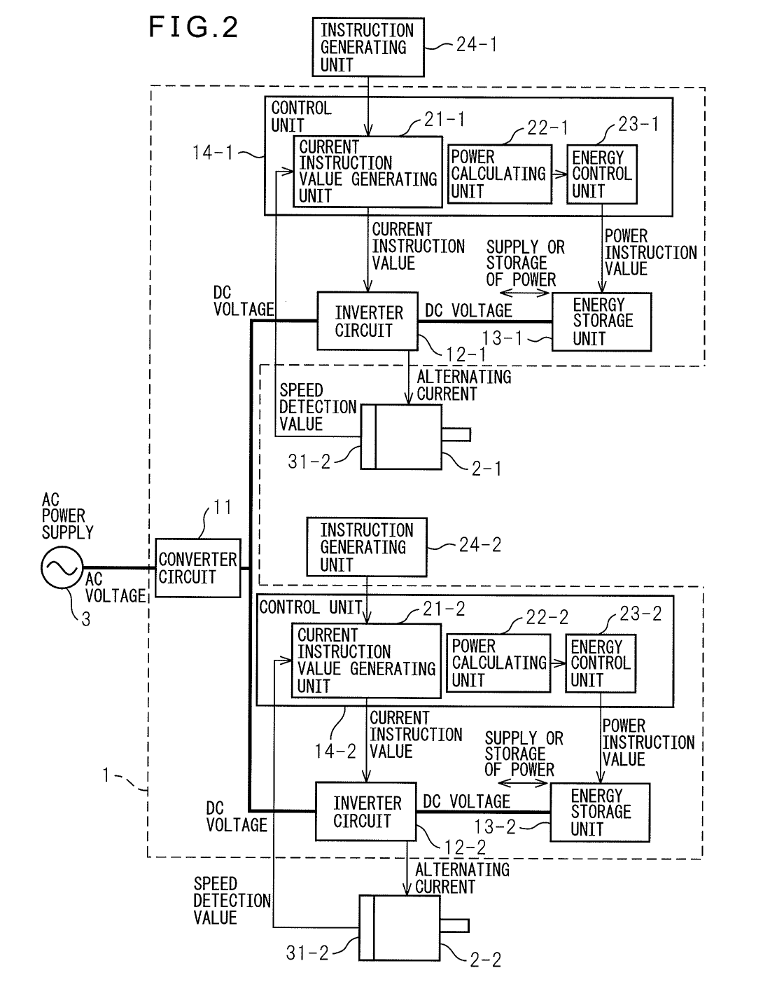

FIG. 2 is a block diagram showing a motor controller controlling a plurality of motors in the embodiment of the invention. In the embodiment shown in FIG. 2, the number of controlled axes of a machine tool is set to two, so that two motors 2-1 and 2-2 are provided, and the motor controller 1 controls the motors 2-1 and 2-2.

As shown in FIG. 2, the motor controller 1 as the embodiment of the invention has: the converter circuit 11 converting AC power from the AC power supply 3 to DC power; inverter circuits 12-1 and 12-2 connected to the DC side of the converter circuit 11 and converting DC power to AC power for driving the motors 2-1 and 2-2 or converting AC power regenerated from the motors 2-1 and 2-2 to DC power; energy storage units 13-1 and 13-2 connected to the DC sides of the converter circuit 11 and the inverter circuits 12-1 and 12-2 and storing or outputting DC power, and control units 14 controlling amount of DC power to be stored or output in/from the energy storage units 13-1 and 13-2 on the basis of a motor operation instruction which instructs operation of the motors 2-1 and 2-2.

Instruction generating units 24-1 and 24-2 generate a motor operation instruction instructing operation of the motors 2-1 and 2-2 and, supply the motor operation instruction to current instruction value generating units 21-1 and 21-2 in the control units 14-1 and 14-2. The motors 2-1 and 2-2 are provided with speed detecting units 31-1 and 31-2 for detecting speed of the rotating motors 2-1 and 2-2, respectively.

The control unit 14-1 has the current instruction value generating unit 21-1, a power calculating unit 22-1, and an energy control unit 23-1. The control unit 14-2 has the current instruction value generating unit 21-2, a power calculating unit 22-2, and an energy control unit 23-2.

Using the motor operation instructions generated by the instruction generating unit 24-1 and 24-2 and the detection values on the rotation of the motors 2-1 and 2-2 detected by the speed detecting units 31-1 and 31-2, the current instruction value generating units 21-1 and 21-2 generate current instruction values to the inverter circuits 12-1 and 12-2, as instruction values by which alternating current necessary for the motors 2-1 and 2-2 to operate are output from the inverter circuits 12-1 and 12-2 in accordance with the motor operation instruction. The power calculating units 22-1 and 22-2 calculate prediction values of power consumed by the motors 2-1 and 2-2 or regenerated from the motors 2-1 and 2-2 on the basis of the motor operation instructions. The energy control units 23-1 and 23-2 control the energy storage units 13-1 and 13-2 so that the DC power amounts to be stored or output in/from the energy storage units 13-1 and 13-2 follow the prediction values calculated by the power calculating units 22-1 and 22-2.

Hereinafter, each of the components of the motor controller 1 controlling the one motor 2 shown in FIG. 1 will be described more specifically. As described above, components to which the same reference numerals are designated in different drawings have the same function, and a component having a reference number and a component having the same reference number with a suffix number have the same function. The following description of each of the components of the motor controller is also applied to the case of controlling a plurality of motors as shown in FIG. 2 as an example.

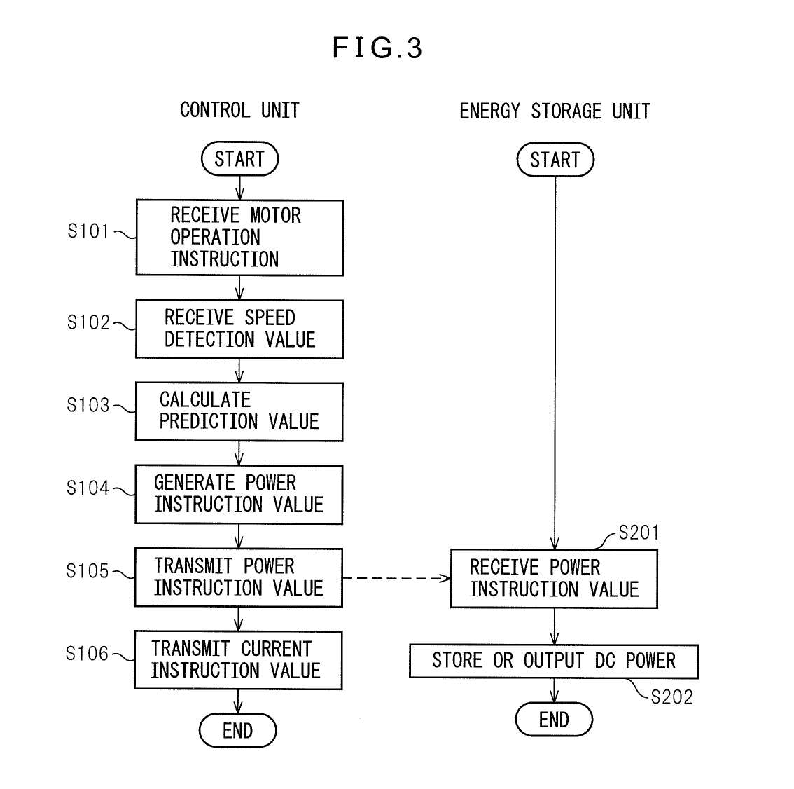

FIG. 3 is a flowchart showing the operation flow of the motor controller as an embodiment of the present invention.

In step S101, the control unit 14 receives a motor operation instruction instructing the operation of the motor 2 generated by the instruction generating unit 24. The motor operation instruction includes an instruction instructing the rotation position of a motor (servo motor) and an instruction instructing the rotation speed of a motor (servo motor). Although the speed detecting unit 31 detects the speed of the rotating motor 2 in the embodiment, in the case where the speed detecting unit 31 detects the rotational speed of the control axis of a machine tool to which the rotary shaft of the motor 2 is connected, the motor operation instruction instructs the rotation position of the control axis of the machine tool or the rotational speed of the control axis of the machine tool. In step S102, the speed detecting unit 31 detects the speed of the rotating motor 2. The order of the processes of steps S101 and S102 does not limit the present invention. The processes may be in reverse order, or the processes may be performed simultaneously.

In step S103, the power calculating unit 22 in the control unit 14 calculates a prediction value of power consumed by the motor 2 or regenerated from the motor 2 on the basis of a motor operation instruction. A concrete calculation equation of a prediction value will be described later.

The energy control unit 23 in the control unit 14 generates a power instruction value on the basis of the prediction value in step S104, and transmits the power instruction value to the energy storage unit 13 in step S105. That is, the energy control unit 23 controls the energy storage unit 13 so that the DC power amount to be stored in or output from the energy storage unit 13 follows the prediction value calculated by the power calculating unit 22.

On the other hand, the energy storage unit 13 receives a power instruction value transmitted from the energy control unit 23 in the control unit 14 in step S201. The energy storage unit 13 which received the power instruction value stores DC power corresponding to the power instruction value from the motor 2 or the AC power supply 3 side or outputs (supplies) the DC power so as to be consumed by the motor 2 or regenerated by the AC power supply 3 side.

In step S106, the current instruction value generating unit 21 in the control unit 14 generates a current instruction value to the inverter circuit 12 using the motor operation instruction generated by the instruction generating unit 24 and the detection value on the rotation of the motor 2 detected by the speed detecting unit 31. The current instruction value is an instruction value to make the inverter circuit 12 output alternating current necessary to operate the motor 2 in accordance with the motor operation instruction. As described above, the motor operation instruction includes an instruction of instructing the rotation position of a motor (servo motor) and an instruction of instructing rotation speed of a motor (servo motor). For example, in the case where the instruction generating unit 24 instructs the speed of the motor 2, the current instruction value generating unit 21 generates a current instruction value from the speed instruction value generated by the instruction generating unit 24 and the speed detection value detected by the speed detecting unit 31. For example, in the case where the instruction generating unit 24 instructs the position of the motor 2, the current instruction value generating unit 21 obtains a speed instruction value from the position instruction value generated by the instruction generating unit 24 and the detection value of the position of the shaft driven by the motor 2 and, generates a current instruction value from the speed instruction value and speed detection value detected by the speed detecting unit 31. The process in step S106 may be executed prior to the processes in steps S103 to S105.

Next, calculation of a prediction value of power consumed by the motor 2 or regenerated from the motor 2 in the power calculating unit 22 will be described.

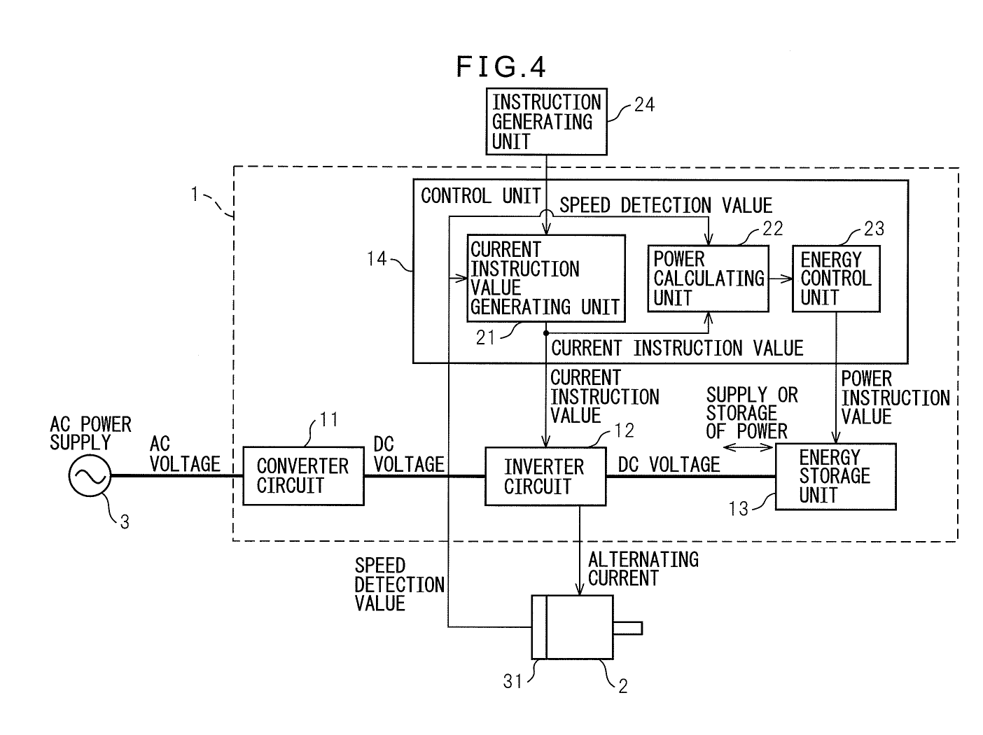

FIG. 4 is a block diagram for explaining a first method of calculation of a prediction value of power in the embodiment of the invention. According to the first method of calculation of a prediction value of power in the embodiment of the invention, the power calculating unit 22 in the control unit 14 calculates a prediction value by multiplying the current instruction value to the inverter circuit 12 generated by the current instruction value generating unit 21, the angular velocity on the motor 2 detected by the speed detecting unit 31 as a detection value on the rotation of the motor 2, and torque constant of the motor 2. A calculation formula of a prediction value of power by the first method is expressed by Equation 1.

Prediction value of power [W]=current instruction value [Ap]×torque constant [Nm/Ap]×angular velocity [rad/s] (1)

There is the possibility that alternating current which flows as drive current from the inverter circuit 12 to the motor 2 largely changes in accordance with the motor operation instruction. Conventionally, using a detection value of direct current flowing from the converter circuit 11 to the inverter 12, the amount of power consumed by the motor or regenerated from the motor is calculated and, on the basis of the power, the amount of power to be stored or output in/from the energy storage unit 13 is controlled. Although the filter for eliminating a noise component from a detection value of direct current is provided as described above, due to the filter, the current detection value has time delay. In contrast, according to the first method of calculating the prediction value of power in the embodiment of the invention, without using the detection value of direct current having the possibility of a large change and, accordingly, without using the detection value of direct current after passage of the filter, the power consumed by the motor 2 or regenerated from the motor 2 is calculated in the form of a “prediction value”. Therefore, the prediction value is not influenced by time delay caused by the noise filter. On the other hand, for the angular velocity of a small change, a detection value of the speed detecting unit 31 is used. Since the actual velocity changes slower than actual current, by using a detection value of angular velocity in which the actual speed of rotation of the motor 2 is reflected, calculation precision on the “prediction value” of the power consumed by the motor 2 or regenerated from the motor 2 can be improved.

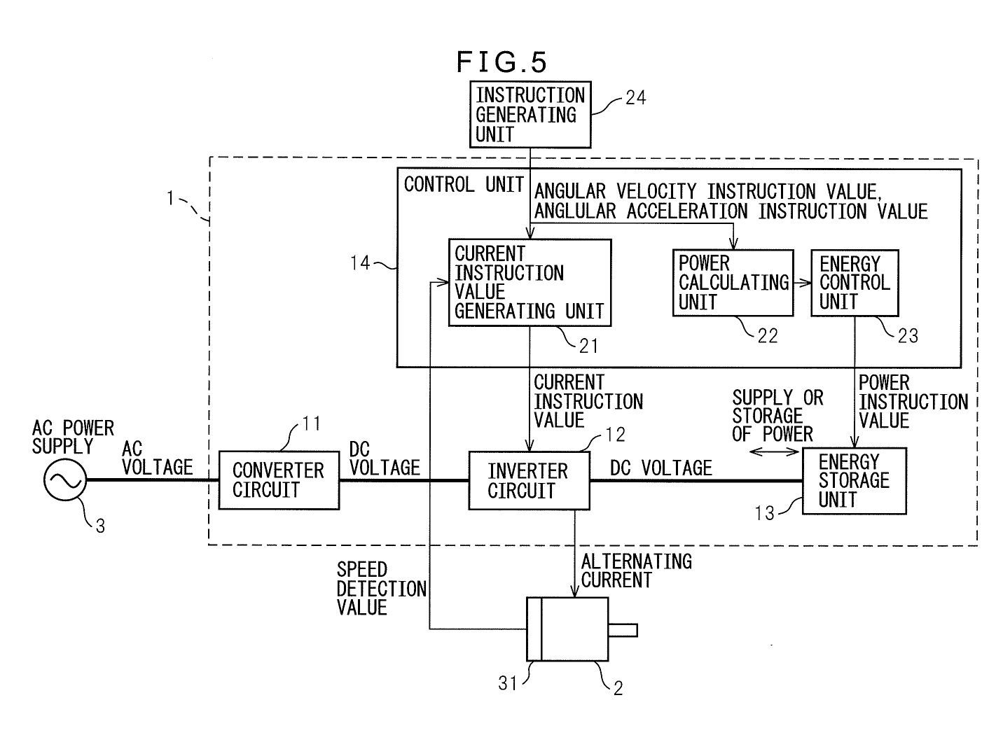

FIG. 5 is a block diagram for explaining a second method of calculation of a prediction value of power in the embodiment of the invention. In the second method of calculation of the prediction value of power in the embodiment of the invention, the power calculating unit 22 in the control unit 14 calculates a prediction value by multiplying an angular velocity instruction value as a motor operation instruction generated by the instruction generating unit 24, an angular acceleration instruction value obtained by differentiating the angular velocity instruction value, and inertia of the drive shaft of the motor 2. A calculation formula of a prediction value of power by the second method is expressed by Equation 2.

Prediction value of power [W]=inertia [kgm²]×angular acceleration instruction value [rad/s²]×angular velocity instruction value [rad/s] (2)

Generally, the motor operation instruction instructing the operation of the motor 2 is preliminarily determined as a program. For example, in the case of a machine tool, an instruction on the operation of the control axis is programmed in advance. Therefore, an instruction value of time ahead of an instruction value of present time, i.e., an instruction of “future time” can be grasped. In the second method of calculation of the prediction value of power in the embodiment of the invention, using the instruction value of “future time” which advances only by the amount of “response delay” from the instruction value of the control system and the energy storage unit, the “prediction value” of power consumed by the motor 2 or regenerated from the motor 2 is calculated. As a result, without being influenced by “response delay” from the instruction value of the control system and the energy storage unit, a power instruction value in the energy control unit 23 at the post stage of the power calculating unit 22 can be generated. In the case where the “response delay” from the instruction value of the control system and the energy storage unit is, for example, tens of milliseconds, the power calculating unit 22 may read an instruction value ahead of present time by tens milliseconds from the motor operation instruction program in the instruction generating unit 24 and, calculate the prediction value of power consumed by the motor 2 or regenerated from the motor 2.

The energy control unit 23 at the post stage of the power calculating unit 22 generates a power instruction value on the basis of the prediction value of power calculated by the power calculating unit 22 as described above and, transmits the power instruction value to the energy storage unit 13. Since the prediction value of power calculated by the power calculating unit 22 is the “prediction value” of the power consumed by the motor 2 or regenerated from the motor 2, in the case where the prediction value is the prediction value of the power consumed by the motor 2, the energy control unit 23 generates a power instruction value of outputting (supplying) a DC power amount corresponding to the prediction value to the motor 2 for the energy storage unit 13. In the case where the prediction value is the prediction value of power regenerated from the motor 2, the energy control unit 23 generates a power instruction value for storing the DC power amount corresponding to the prediction value from the motor 2 for the energy storage unit 13.

In such a manner, the energy control unit 23 controls the energy storage unit 13 so that the DC power amount to be stored/output in/from the energy storage unit 13 follows the prediction value calculated by the power calculating unit 22. When the converter circuit 11 converts not only AC power from the AC power supply 3 to DC power but also DC power to AC power, that is, when the converter circuit 11 converts the AC power and DC power mutually, the energy control unit 23 may control the DC power amount to be stored/output in/from the energy storage unit 13 in a range that does not exceed maximum conversion permissible power of the converter circuit 11 capable of mutually converting the AC power and DC power by the converter circuit 11 (for example, about 70 to 80 percent of the maximum supply power). Alternatively, the energy control unit 23 may control the DC power amount to be stored/output in/from the energy storage unit 13 in a range that does not exceed the maximum supply power that the AC power supply 3 connected to the converter circuit 11 can supply to the converter circuit 11 (for example, about 70 to 80 percent of the maximum supply power). In such a manner, for example, in the case where the power stored in the energy storage unit 13 is depleted (or is going to be depleted), power is supplied from the AC power supply 3 side to the motor 2 and, in addition, power for charging is also supplied from the AC power supply 3 side to the energy storage unit. Even in such a case, the power does not exceed the maximum conversion permissible power of the converter circuit 11 and the maximum supply power which can be supplied from the AC power supply 3 to the converter circuit 11. As described above, in the embodiment of the invention, the capacity of the AC power supply and that of the converter circuit can be reduced, so that a motor controller which is smaller and cheaper than a conventional one can be realized.

Next, the energy storage unit 13 will be described.

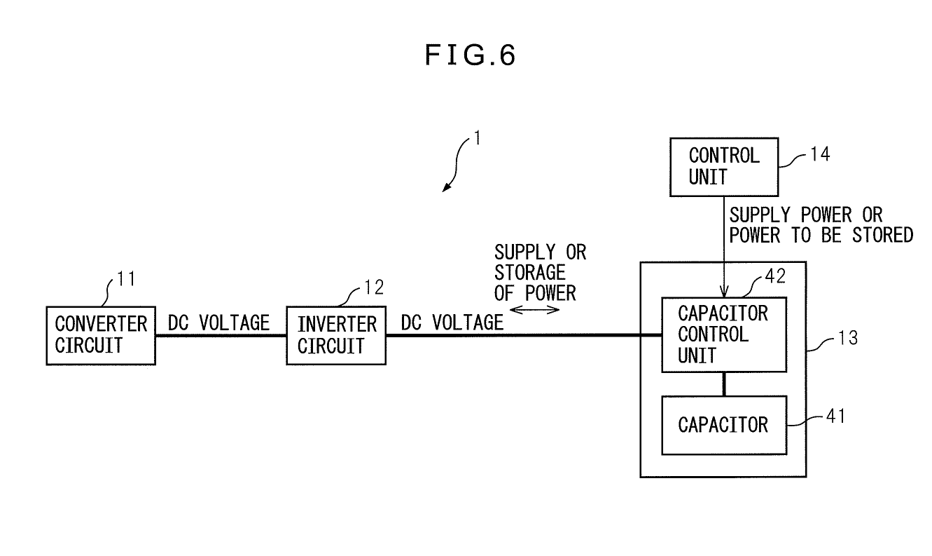

FIG. 6 is a block diagram for explaining a first concrete example of the energy storage unit in the embodiment of the invention. In the diagram, the motor connected to the inverter circuit 12 and the AC power supply connected to the converter circuit 11 are not shown.

The energy storage unit 13 as the first concrete example has a capacitor 41 connected to the DC side of the converter circuit 11 and the inverter circuit 12, and a capacitor control unit 42 performs control so that the capacitor 41 stores or outputs DC power in accordance with the power instruction value generated by the energy control unit 23 on the basis of the prediction value calculated by the power calculating unit 22. In this case, the energy control unit 23 in the control unit 14 controls the DC power amount to be stored or output in/from the capacitor 41 on the basis of the prediction value calculated by the power calculating unit 22. The capacitor control unit 42 can be a processor which can determine process.

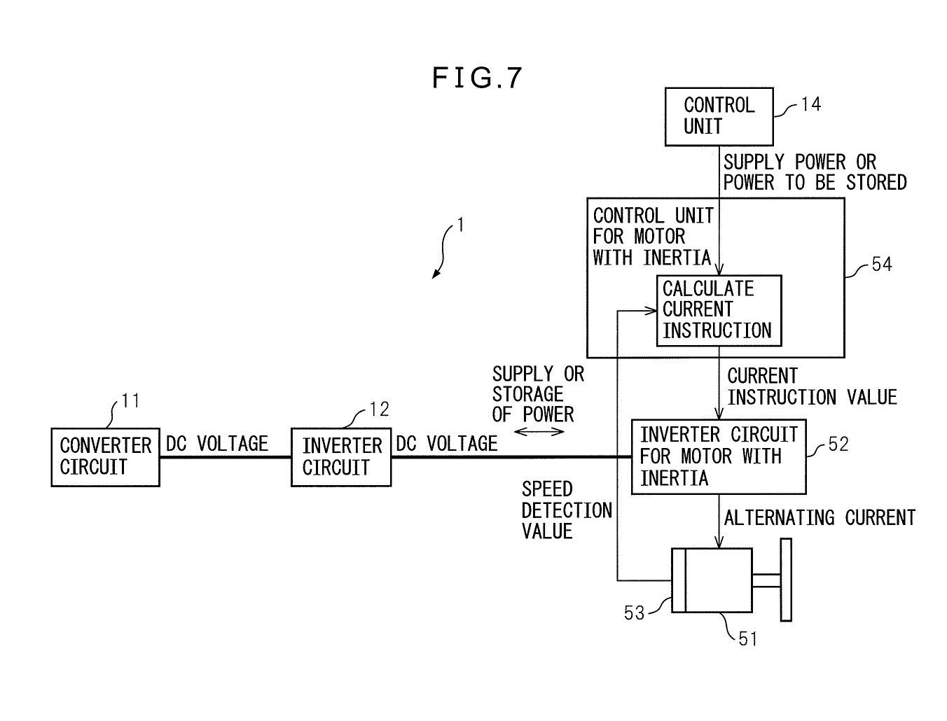

FIG. 7 is a block diagram for explaining a second concrete example of the energy storage unit in the embodiment of the invention. In the diagram, the motor connected to the inverter circuit 12 and the AC power supply connected to the converter circuit 11 are not shown.

The energy storage unit 13 as the second concrete example has a motor 51 with inertia, an inverter circuit 52 for the motor with inertia, whose DC side is connected to the DC sides of the converter circuit and the inverter circuit, and whose AC side is connected to the input terminal of the motor with inertia, a motor speed detecting unit 53 for detecting the speed of the motor with inertia, and a control unit 54 for the motor with inertia. Using the power instruction value generated by the energy control unit 23 on the basis of the prediction value calculated by the power calculating unit 22 and a detection value of the speed of the motor 51 with inertia received from the motor speed detecting unit 53, the control unit 54 for the motor with inertia generates a current instruction value for the inverter circuit 52 for the motor with inertia so that the DC power amount follows the prediction value.

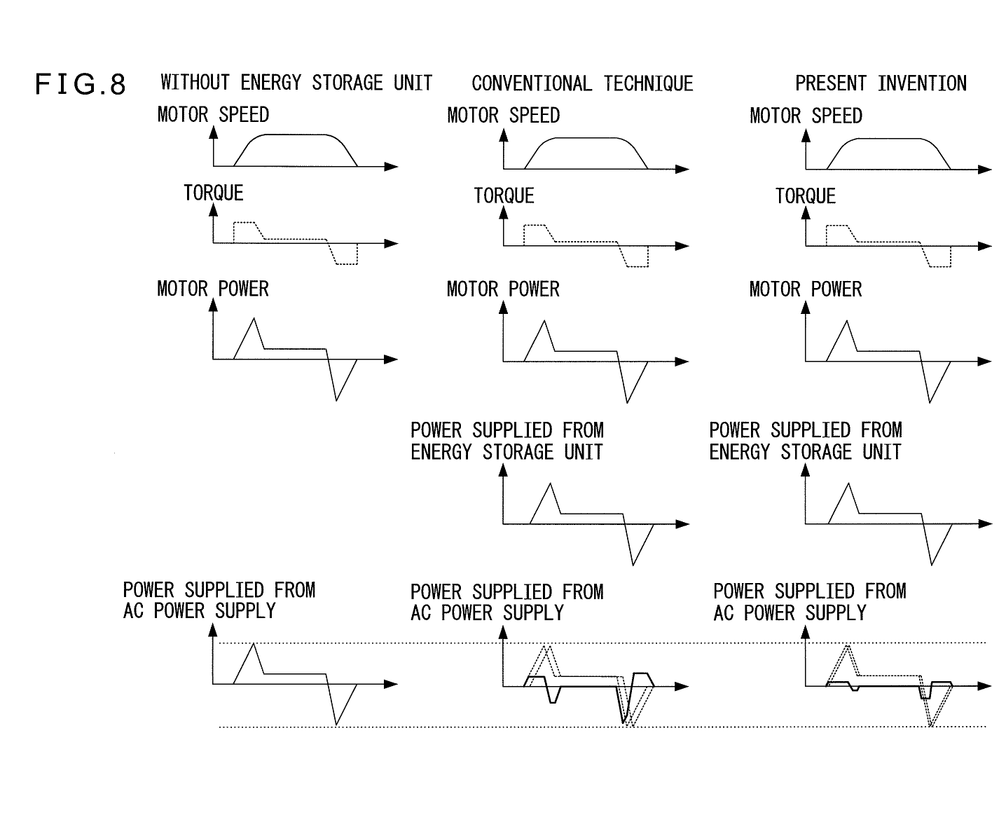

FIG. 8 is a diagram for explaining suppression of a peak value of AC power supplied from the AC power supply in the case of applying the motor controller as the embodiment of the present invention, and shows waveform charts of the case where there is no energy storage unit, the conventional technique having the energy storage unit, and the present invention. It is assumed that FIG. 8 shows the waveforms of motor speed, torque of the motor, power consumed by the motor or regenerated from the motor, and power supplied from the AC power supply and regenerated to the AC power supply in the case where the motor is controlled by the motor controller having no energy storage unit. According to the present invention, as illustrated in FIG. 8, there is no delay in the waveform of the power supplied or stored from/in the energy storage unit from the waveform of power consumed by the motor or regenerated from the motor, so that the peak value of each of the waveforms of the power supplied from the AC power supply and power regenerated to the AC power supply. In contrast, in the conventional technique provided with the energy storage unit, as shown in FIG. 8, the waveform of the power supplied or stored from/in the energy storage unit has a delay as compared with the waveform of the power consumed by the motor or regenerated by the motor for the above-described reason. Consequently, the peak values of the waveforms of the power supplied from the AC power supply and regenerated to the AC power supply are not suppressed so much as the present invention.

As described above, according to the present invention, using the prediction value of power consumed or regenerated by the motor, which is calculated on the basis of the motor operation instruction instructing the angle, angular velocity, or angular acceleration to the motor, the control is performed so that the amount of DC power to be stored or output in/from the energy storage unit follows the prediction value. Consequently, the influence of time delay in the filter and operation delay in the energy storage unit can be eliminated, and the peak values of currents in the AC power supply connected to the motor controller and the converter circuit in the motor controller can be suppressed. Therefore, according to the present invention, the capacity of the AC power supply and the capacity of the converter circuit can be reduced, so that a smaller and lower-cost motor controller can be realized comparing to the conventional technique.

The present invention can be applied to the case of driving motors (servo motors) in a machine tool system having the motors for respective drive shafts of machine tool by a motor controller having a converter circuit converting input alternating current to direct current and an inverter circuit converting the direct current output from the converter circuit to alternating current to be supplied as drive power of each of the motors.

What is claimed is:

1. A motor controller comprising:
a converter circuit for converting AC power to DC power;
an inverter circuit connected to a DC side of the converter circuit and converting DC power to AC power for driving a motor or converting AC power regenerated from the motor to DC power;
an energy storage unit connected to the DC sides of the converter circuit and the inverter circuit and storing or outputting DC power; and
a control unit controlling DC power amount to be stored in or output from the energy storage unit on the basis of a motor operation instruction instructing angle, angular velocity or angular acceleration to the motor.

2. The motor controller according to claim 1, wherein the motor operation instruction is an instruction in present time or future time later than the present time.

3. The motor controller according to claim 1, wherein the control unit comprises:
a power calculating unit calculating a prediction value of power consumed by the motor or regenerated from the motor on the basis of the motor operation instruction; and
an energy control unit controlling the energy storage unit so that the DC power amount follows the prediction value.

4. The motor controller according to claim 3, wherein the control unit has a current instruction value generating unit, using the motor operation instruction and a detection value on rotation of the motor, which generates a current instruction value to the inverter circuit, as an instruction value instructing the inverter circuit to output alternating current necessary for the motor to operate in accordance with the motor operation instruction.

5. The motor controller according to claim 4, wherein the power calculating unit calculates the prediction value by multiplying the current instruction value, angular velocity detected on the motor as the detection value, and torque constant of the motor.

6. The motor controller according to claim 3, wherein the power calculating unit calculates the prediction value by multiplying an angular velocity instruction value as the motor operation instruction, an angular acceleration instruction value obtained by differentiating the angular velocity instruction value, and inertia of the drive shaft of the motor.

7. The motor controller according to claim 1, wherein the converter circuit mutually converts AC power from an AC power supply and DC power, and
the energy control unit controls the DC power amount to be stored in or output from the energy storage unit within a range not exceeding maximum conversion permissible power of the converter circuit capable of converting the AC power and DC power mutually.

8. The motor controller according to claim 1, wherein the converter circuit mutually converts AC power from an AC power supply and DC power, and
the energy control unit controls the DC power amount to be stored in or output from the energy storage unit within a range not exceeding maximum supply power which can be supplied from the AC power supply connected to the converter circuit, to the converter circuit.

9. The motor controller according to claim 3, wherein the energy storage unit comprises:
a capacitor connected to the DC sides of the converter circuit and the inverter circuit; and
a capacitor control unit controlling the capacitor to store or output DC power in accordance with an instruction from the energy control unit based on the prediction value calculated by the power calculating unit.

10. The motor controller according to claim 3, wherein the energy storage unit comprises:
a motor with inertia;
an inverter circuit for the motor with inertia, whose DC side is connected to the DC sides of the converter circuit and the inverter circuit and whose AC side is connected to an input terminal of the motor with inertia;
a motor speed detecting unit detecting speed of the motor with inertia; and
a control unit for the motor with inertia, using the prediction value and a detection value of speed of the motor with inertia received from the motor speed detecting unit, generating a current instruction value to the inverter circuit for the motor with inertia so that the DC power amount follows the prediction value.
